(19) United States
(12) Patent Application Publication
(10) Pub. No.: US 2022/0198376 A1
(43) Pub. Date: Jun. 23, 2022

(54) DYNAMIC UPDATE OF CHARGEBACKS FOR SPACE ALLOCATION

(71) Applicant: International Business Machines Corporation, Armonk, NY (US)

(72) Inventors: Lisa Seacat DeLuca, Bozeman, MT (US); David Blanch, Austin, TX (US)

(21) Appl. No.: 17/124,941

(22) Filed: Dec. 17, 2020

(51) Int. Cl. G06Q 10/08; G06Q 30/02; G06F 9/38

(52) U.S. Cl. CPC G06Q 10/087; G06F 9/3836; G06Q 30/0206

(57) ABSTRACT

An average usage of floorspace by one or more organizations utilizing the floorspace is determined. In response to determining that for at least one organization of the one or more organizations a usage delta between the average usage of floorspace and an allocated floorspace amount associated with the at least one organization exceeds a threshold, an adjusted cost associated with the at least one organization is calculated.

### BACKGROUND

The present invention relates generally to the field of space allocation, and more particularly to providing dynamic updating of chargebacks for space allocations.

Several tools exist in the marketplace for facilities management. Each tool considers features such as space allocation, creating safer spaces, a focus on employee well-being, protocol management (e.g., cleaning schedules), and controlling costs. A space allocation can be defined as an association between a space record representing a physical space within a facility (which may be defined using a polygon against a floor layout or drawing) and one or more organization records. These allocations can be used for internal financial purposes to both assign ownership and/or subdivide the operating costs of the facility to such organization, a process also known as chargeback. The space record can be further granulated to the space assignment which is an association between a person and a space record. Space allocations and space assignments are both space associations which is a relationship between the space record and various associated records.

### SUMMARY OF THE INVENTION

Embodiments of the present invention include an approach for providing dynamic updating of chargebacks for space allocations. In one embodiment, an average usage of floorspace by one or more organizations utilizing the floorspace is determined. In response to determining that for at least one organization of the one or more organizations a usage delta between the average usage of floorspace and an allocated floorspace amount associated with the at least one organization exceeds a threshold, an adjusted cost associated with the at least one organization is calculated.

### BRIEF DESCRIPTION OF THE DRAWINGS

FIG. 1 depicts a functional block diagram illustrating a computing environment which includes a dynamic chargeback program, in accordance with an embodiment of the present invention;

FIG. 2 is a flowchart depicting operational steps of a program for providing dynamic updating of chargebacks for space allocations, on a computing device within the computing environment of FIG. 1, in accordance with an embodiment of the present invention;

FIG. 3A depicts an example space allocation for a floor in an office building, in accordance with an embodiment of the present invention;

FIG. 3B depicts an example change to the space allocation of FIG. 3A, in accordance with an embodiment of the present invention;

FIG. 3C depicts another example change to the space allocation of FIG. 3A, in accordance with an embodiment of the present invention;

FIG. 3D depicts yet another example change to the space allocation of FIG. 3A, in accordance with an embodiment of the present invention; and

FIG. 4 depicts a block diagram of components of a computing device executing a dynamic chargeback program within the computing environment of FIG. 1, in accordance with an embodiment of the present invention.

### DETAILED DESCRIPTION

Embodiments of the present invention recognize that space allocation are subject to change over time. An office building, for example, may be occupied by several organizations within the same company, each of those organizations sharing in the cost of occupying the building via their annual budgets. In another scenario, two or more companies may occupy space within the same office building. One of those companies may be the landlord for the building while the others are tenants, or another separate company may be the landlord for the building with all of the companies that occupy space in the building as tenants (i.e., the landlord does not occupy space in the building). A system is needed that is able to apply insights from data transmitted by Internet of things (IoT) devices to identify discrepancies in current floorspace allocations.

Embodiments of the present invention recognize that there may be a method, computer program product, and computer system for providing dynamic updating of chargebacks for space allocations. The method, computer program product, and computer system improve the technology of chargebacks controlled by a finance organization within a company for a workplace such as an office building. A chargeback is the policy of allocating the cost of floorspace, the floorspaces subdivided therein, and other resources to the individuals and/or organizations which use the floorspace. Here, an improvement derived from the present invention is the dynamic determination of real-time floorspace usage and the updating of chargebacks based on the said real-time usage. The use of a suite of IoT devices and one or more computer processors enable the dynamic determination of the floorspace providing an improvement to current floorspace allocation tools used by a company. For example, if two separate occupants (e.g., ‘A’ and ‘B’) within the same company equally share a floor within an office building, each occupant should be charged half of the costs associated with the floorspace. If occupant ‘A’ institutes a work-from-home policy for half of its employees, half of the floorspace used by ‘A’ becomes unused. The present invention will identify this change in floorspace allocation and dynamically update the chargeback to occupant ‘A’ by cutting its cost in half. In this example, the cost of the empty floorspace would revert to the landlord (i.e., owner) of said floorspace. If occupant ‘B’ expands into this empty floorspace (formerly utilized by occupant ‘A’), the present invention would identify this change in floorspace allocation and dynamically update the chargeback to ‘B’ thus increasing its cost by fifty-percent. This dynamic, real-time updating of the chargebacks will help a company maintain more accurate costs associated with the various occupants (i.e., organizations) within the company.

In an embodiment, an input is received of a current floorspace allocation. In the embodiment, people with the area of the floorspace are identified based on individual opt-in and opt-out indications from each person within the area. Further in the embodiment, associations are determined between the people, their respective organizations, and the received current floorspace allocation. Further yet in the embodiment, an average floorspace usage by person/organization is determined. Further yet in the embodiment, a determination is made whether the delta between the current floorspace usage and the actual floorspace usage exceeds a threshold. Further yet in the embodiment, in response to determining that a usage delta exceeds a threshold, a notification is transmitted. Further yet in the embodiment, an adjusted chargeback is calculated. Further yet in the embodiment, a revised invoice is transmitted. Further yet in the embodiment, a new floorspace allocation is recommended. Further yet in the embodiment, a determination is made whether the recommendation is approved. Further yet in the embodiment, in response to determining that the recommendation was approved, the new floorspace allocation is stored.

References in the specification to “one embodiment”, “an embodiment”, “an example embodiment”, etc., indicate that the embodiment described may include a particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The present invention will now be described in detail with reference to the Figures.

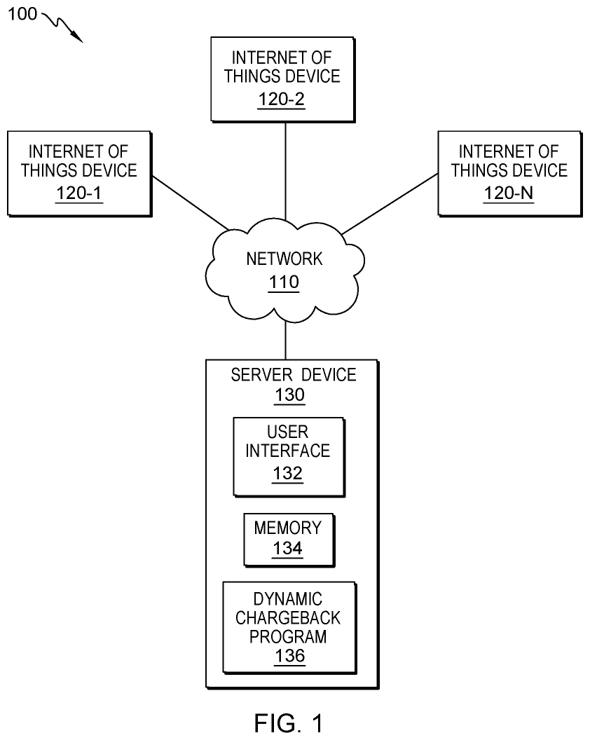

FIG. 1 is a functional block diagram illustrating a computing environment, generally designated 100, in accordance with one embodiment of the present invention. FIG. 1 provides only an illustration of one implementation of the present invention and does not imply any limitations with regard to the systems and environments in which different embodiments may be implemented. Many modifications to the depicted embodiment may be made by those skilled in the art without departing from the scope of the invention as recited by the claims.

In an embodiment, computing environment 100 includes Internet of things (IoT) device 120-1, IoT device 120-2, IoT device 120-N, and server device 130 interconnected by network 110. In example embodiments, computing environment 100 includes other computing devices (not shown in FIG. 1) such as additional wearable technology, cell phones, smartphones, phablets, tablet computers, wireless charging devices, laptop computers, desktop computers, other computer servers, or any other computer system known in the art, interconnected with IoT device 120-1, IoT device 120-2, IoT device 120-N, and server device 130 over network 110. For ease of reading, IoT device 120-N will be used to represent any instance of an IoT device (e.g., IoT device 120-1, IoT device 120-2, and any other IoT devices).

In embodiments of the present invention, IoT device 120-N and server device 130 are connected to network 110, which enables IoT device 120-N and server device 130 to access other computing devices and/or data not directly stored on IoT device 120-N and server device 130. Network 110 may be, for example, a short-range, low power wireless connection, a local area network (LAN), a telecommunications network, a wide area network (WAN) such as the Internet, or any combination of the four, and include wired, wireless, or fiber optic connections. Network 110 includes one or more wired and/or wireless networks that are capable of receiving and transmitting data, voice, and/or video signals, including multimedia signals that include voice, data, and video information. In general, network 110 is any combination of connections and protocols that will support communications between IoT device 120-N, server device 130, and any other computing devices (not shown in FIG. 1) connected to network 110, in accordance with embodiments of the present invention.

According to embodiments of the present invention, IoT device 120-N is a computing device in a system of interrelated computing devices that are provided with unique identifiers (UIDs) and the ability to transmit and receive data over a network without requiring human-to-human or human-to-computer interaction. Application uses for IoT device 120-N include, but are not limited to, business, consumer, commercial, industrial, infrastructure, and military applications. In an embodiment, IoT device 120-N is a device used in a business application, or more specifically, a workplace. In the embodiment, examples of IoT device 120-N include, but are not limited to, room occupancy sensors, desk occupancy sensors, cameras (e.g., still photograph and/or video), image sensors, badge readers, proximity sensors, passive infrared (IR) sensors (i.e., motion detectors), temperature sensors, humidity sensors, wireless devices (e.g., laptop computer, mobile phone, etc.) directly authenticated to a network, or any other similar sensor or control used in a workplace such as an employee cafeteria or office area. According to an embodiment, IoT device 120-N is any electronic device capable of identifying a person and/or associating a person with an organization. The primary function of IoT device 120-N in the embodiment is to identify one or more people in an area such as an office building and to also identify the respective departments or organizations of the one or more people.

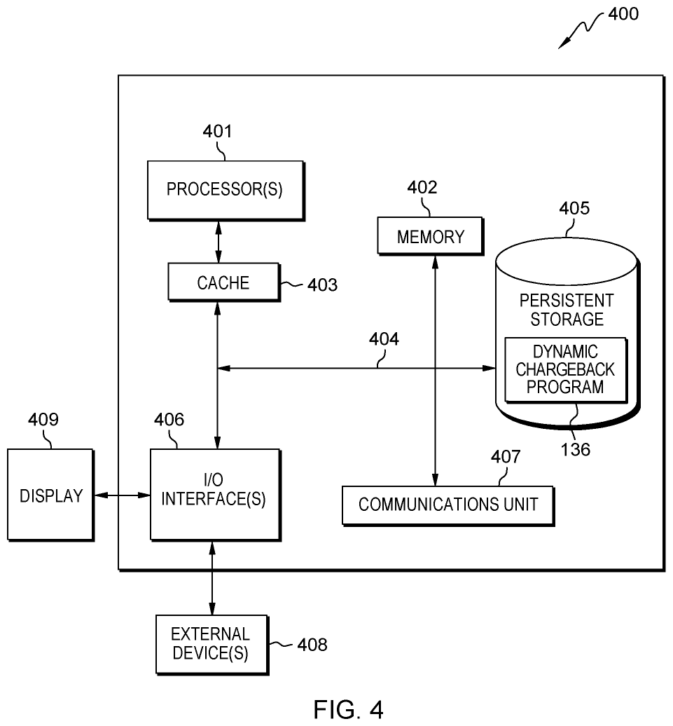

In an embodiment of the present invention, server device 130 may be one of a laptop, tablet, or netbook personal computer (PC), a desktop computer, a personal digital assistant (PDA), a smartphone, a standard cell phone, a smartwatch or any other wearable technology, or any other hand-held, programmable electronic device capable of communicating with any other computing device within computing environment 100. According to embodiments, server device 130 can be a standalone computing device, a management server, a web server, a mobile computing device, or any other electronic device or computing system capable of receiving, transmitting, and processing data. In other embodiments, server device 130 can represent computing systems utilizing multiple computers as a server system, such as in a cloud computing environment. In certain embodiments, server device 130 represents a computer system utilizing clustered computers and components (e.g., database server computers, application server computers, etc.) that act as a single pool of seamless resources when accessed by elements of computing environment 100. In general, server device 130 is representative of any electronic device or combination of electronic devices capable of executing computer readable program instructions. In an embodiment, computing environment 100 includes any number of server device 130. Server device 130 may include internal and external hardware components as depicted and described in further detail with respect to FIG. 4, in accordance with embodiments of the present invention. In an embodiment, server device 130 also includes user interface (UI) 132, memory 134, and dynamic chargeback program 136.

In an embodiment, UI 132 provides an interface between a user of server device 130 and dynamic chargeback program 136. UI 132 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. UI 132 may also be mobile application software that provides an interface between server device 130 and dynamic chargeback program 136. Mobile application software, or an “app,” is a computer program designed to run on smartphones, tablet computers and other mobile devices. UI 132 enables a user of server device 130 to interact with IoT device 120-N, dynamic chargeback program 136, any other programs and applications included on server device 130 (not shown in FIG. 1), and any other computing devices (not shown in FIG. 1).

According to an embodiment, memory 134 is storage that is written to and/or read by dynamic chargeback program 136, and any other programs and applications on IoT device 120-N and server device 130. In one embodiment, memory 134 resides on server device 130. In other embodiments, memory 134 resides on IoT device 120-N, on any other device (not shown in FIG. 1) in computing environment 100, in cloud storage, or on another computing device accessible via network 110. In yet another embodiment, memory 134 represents multiple storage devices within server device 130. Memory 134 may be implemented using any volatile or non-volatile storage media for storing information, as known in the art. For example, memory 134 may be implemented with a tape library, optical library, one or more independent hard disk drives, multiple hard disk drives in a redundant array of independent disks (RAID), solid-state drives (SSD), or random-access memory (RAM). Similarly, memory 134 may be implemented with any suitable storage architecture known in the art, such as a relational database, an object-oriented database, or one or more tables. In an embodiment of the present invention, IoT device 120-N, dynamic chargeback program 136, and any other programs and applications (not shown in FIG. 1) operating on server device 130 may store, read, modify, or write data to memory 134. In an embodiment of the present invention, data stored to memory 134 includes, but is not limited to, data from IoT device 120-N, current floorspace allocation data, current chargeback information, average floorspace usage by person/organization, floorspace usage deltas between allocated and actual usage, and recommended floorspace allocations.

In an embodiment of the present invention, dynamic chargeback program 136 is a program, a subprogram of a larger program, an application, a plurality of applications, or mobile application software, which functions to provide dynamic updates to chargebacks for space allocations. A program is a sequence of instructions written to perform a specific task. In an embodiment, dynamic chargeback program 136 runs independently. In other embodiments, dynamic chargeback program 136 depends on system software and/or other programs (not shown in FIG. 1) to execute. According to an embodiment, dynamic chargeback program 136 is a cognitive system based on artificial intelligence utilizing machine learning and deep learning which analyzes data received from one or more IoT sensors or other personally identifiable devices such as a laptop computer and a mobile phone (i.e., smartphone), determines whether a delta exists between a specified floorspace allocation and an actual usage of floorspace (e.g., for the specified floorspace, department ‘A’ should occupy fifty percent of the floorspace and department ‘B’ should occupy fifty percent; however, the actual usage is department ‘A’ utilizes seventy-five percent and department ‘B’ uses twenty-five percent meaning that department ‘A’ is paying fifty percent less than it should while department ‘B’ is paying fifty percent more than it should). In one embodiment, dynamic chargeback program 136 functions as a stand-alone program residing on server device 130. In another embodiment, dynamic chargeback program 136 works in conjunction with other programs, applications, etc., found in computing environment 100. In yet another embodiment, dynamic chargeback program 136 resides on other computing devices such as IoT device 120-N in computing environment 100, which are interconnected to server device 130 via network 110.

According to an embodiment, dynamic chargeback program 136 receives input of one or more current floorspace allocations (which can be maintained in external systems, including but not limited to Computer-Aided Facility Management (CAFM) and Integrated Workplace Management System (IWMS)). In the embodiment, dynamic chargeback program 136 identifies one or more people in an area such as an office building, laboratory space, manufacturing space in a factory, etc. Further in the embodiment, dynamic chargeback program 136 determines associations between the one or more people, their respective departments/organizations, and the associated floorspace allocations for the area. Further yet in the embodiment, dynamic chargeback program 136 determines an average usage of the floorspace by the department/organization. Further yet in the embodiment, dynamic chargeback program 136 determines whether a usage delta between the average usage (i.e., actual usage over a period of time) and the specified floorplan usage in the current floorspace allocation exceeds a threshold. Further yet in the embodiment, in response to determining that a usage delta exceeds a threshold, dynamic chargeback program 136 transmits a notification. Further yet in the embodiment, dynamic chargeback program 136 calculates an adjusted chargeback based on the usage delta. Further yet in the embodiment, dynamic chargeback program 136 stores information. Further yet in the embodiment, dynamic chargeback program 136 transmits a revised invoice. Further yet in the embodiment, dynamic chargeback program 136 recommends a new floorspace allocation. Further yet in the embodiment, dynamic chargeback program 136 determines whether the new floorspace allocation is approved. Further yet in the embodiment, in response to determining that the new floorspace allocation is approved, dynamic chargeback program 136 stores the new floorspace allocation as the current floorspace allocation.

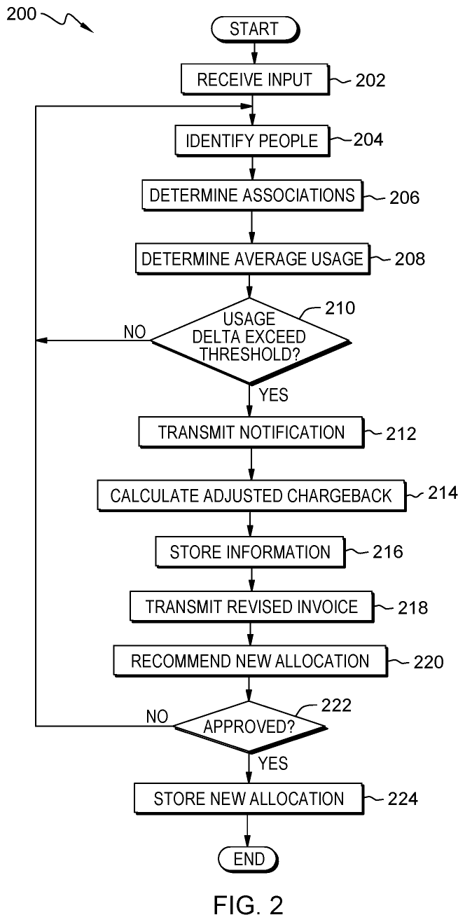

FIG. 2 is a flowchart of workflow 200 depicting operational steps for providing dynamic updates of chargebacks for space allocations. In one embodiment, the method of workflow 200 is performed by dynamic chargeback program 136. In an alternative embodiment, the method of workflow 200 is performed by any other program in computing environment 100 working with dynamic chargeback program 136. In an embodiment, a user of server device 130 invokes workflow 200 upon accessing dynamic chargeback program 136. In an alternative embodiment, workflow 200 is dynamically invoked upon IoT device 120-N detecting the presence of a person in an area.

In an embodiment, dynamic chargeback program 136 receives input (step 202). In other words, dynamic chargeback program 136 receives an input of the current floorspace allocation for a for an area such as an office building. In the embodiment, dynamic chargeback program 136 can receive the input from a person, a database (i.e., a memory), or from another program. The floorspace allocation can be input in any method known in the art (e.g., a percentage used, per square foot of space used, etc.). In an embodiment, dynamic chargeback program 136 receives from memory 134 on server device 130 a current floorspace allocation for a company. For example, a program on the company server receives the following floorspace allocation from the manager (i.e., ‘Bill’) of the Finance department: each of (i) Sales, (ii) Engineering, (iii), Human Resources (HR), and (iv) Finance are allocated one-fourth (i.e., twenty-five percent) of the floorspace with the building. Given that the monthly costs to occupy the building are ten thousand dollars, each organization pays a monthly cost of two thousand five hundred dollars for their respective floorspace allocation.

According to an embodiment of the present invention, dynamic chargeback program 136 identifies people (step 204). In other words, dynamic chargeback program 136 identifies the people in an area using one or more Internet of things (IoT) sensors (the area being the space which is monitored by the one or more IoT sensors; for example, an office area, a classroom, a manufacturing floor, etc.). According to an embodiment, dynamic chargeback program 136 may identify one person (e.g., when a person is alone in the given area) or may identify more than one person (e.g., when a group of people are in the given area). Examples of the given area include, but are not limited to, an office building, a cafeteria, a factory, a school (e.g., grade school, high school, college), a restaurant, and the like. IoT sensors used by dynamic chargeback program 136 to identify people include, but are not limited to, still cameras, video cameras, sensors that measure Wi-Fi (wireless fidelity) signals, voice recognition, employee badge readers, and sensors that detect electromagnetic radiation from electronic devices. Prior to identifying the people, dynamic chargeback program 136 receives opt-in from the people. Dynamic chargeback program 136 may utilize various accessible data sources that may include personal data, content, or information the one or more users wish not to be processed. Personal data includes personally identifying information or sensitive personal information as well as user information, such as tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. Opting-in to use dynamic chargeback program 136 enables the authorized and secure processing of personal data as well as monitoring the opted-in users' movements and interactions with other opted-in users. Dynamic chargeback program 136 provides informed consent, with notice of the collection of personal data, allowing the one or more users to opt-in or opt-out of processing personal data. Consent can take several forms. Opt-in consent can impose on a user to take an affirmative action before personal data is processed. Alternatively, opt-out consent can impose on the user to take an affirmative action to prevent the processing of personal data before personal data is processed. Dynamic chargeback program 136 provides information regarding personal data and the nature (e.g., type, scope, purpose, duration, etc.) of the processing. Dynamic chargeback program 136 provides the one or more users with copies of stored personal data. Further, dynamic chargeback program 136 allows for the correction or completion of incorrect or incomplete personal data and also allows for the immediate deletion of personal data. According to an embodiment, dynamic chargeback program 136 identifies the people in a given area using data received over network 110 from a plurality of IoT device 120-N; in the embodiment, only the people who have opted-in are identified (i.e., a person who has not opted-in is ignored by dynamic chargeback program 136). For example, the program on the company server identifies all of the people in the office building that work in the Sales, Engineering, HR, and Finance organizations via IoT devices such as cameras, Wi-Fi signal sensors, and the like.

In an embodiment, dynamic chargeback program 136 determines associations (step 206). In other words, responsive to identifying the people within an area, dynamic chargeback program 136 determines various associations for each of the people (i.e., what floorspace allocation is each person associated with; for example, what organization does the person work for such as ‘Bill’ works for the Finance organization as manager). According to an embodiment, dynamic chargeback program 136 determines the respective associations by retrieving the information from a company directory or other company documentation stored to a memory. In an embodiment, dynamic chargeback program 136 determines the association of each of the identified people in the area by retrieving information from memory 134 on server device 130. For example, the program on the company server determines the following associations: there are ten Sales employees (S1-S10), there are nine Engineering employees (E1-E9), there are eleven HR employees (HR1-HR11), and there are seven Finance employees (F1-F7).

According to an embodiment, dynamic chargeback program 136 determines average usage (step 208). In other words, dynamic chargeback program 136 monitors the area and determines the average utilization of the floorspace by organization of a given period of time. In an embodiment, dynamic chargeback program 136 continuously identifies the people in the area within the given time period and determines their respective associations using the methodologies discussed above. For example, if five people (AP1 through AP5) occupy space ‘A’ and ten people (BP1 through BP10) occupy space ‘B’, dynamic chargeback program 136 continuously monitors, over a time frame, the fifteen people. A program such as dynamic chargeback program 136 then determines that the five people occupied space ‘A’ ninety-four percent of the time; other people occupied space ‘A’ the remaining four percent of time. This is done by summing the time in space ‘A’ for each of AP1 through AP5, adding the sums together, dividing by the time frame, and multiplying by one hundred to determine the percent time. For an eight hour day, each of AP1 through AP5 spends seven and a half hours in space ‘A’; the calculation is then (“7.5+7.5+7.5+7.5+7.5”=“37.5” hours)/“40” hours*“100”=“93.8” percent. Using a similar calculation, space ‘B was occupied by the ten people eighty-nine percent of the time and other people occupied space ‘B’ the remaining eight percent of the time. Dynamic chargeback program 136 then can determine the average usage by each identified organization over the given period of time (e.g., a month, a quarter, a year, etc.). According to an embodiment, dynamic chargeback program 136 determines the average usage of the floorspace based on data received from IoT device 120-N over a one month time frame. For example, the program on the company server determines that for the first month, each of the four organizations (i.e., Sales, Engineering, HR, and Finance) occupy the allocated floorspace per the current, documented allocation (i.e., each organization uses one-fourth of the floorspace). However, in the second month the Sales organization was directed to work remotely (thus the Sales organization did not use any floorspace in that second month) and the Engineering organization quickly expanded into the floorspace previously utilized by Sales.

In an embodiment, dynamic chargeback program 136 determines whether a usage delta exceeds a threshold (decision step 210). In other words, dynamic chargeback program 136 compares the allocated floorspace usage against the actual, real-time floorspace usage and determines whether a delta in the usage exceeds a threshold (e.g., ten percent, twenty-five percent, fifty-percent, etc.). For example, if HR holds their weekly meetings in a conference room located in an area allocated to Finance, HR may be required to pay a portion of the cost of the floorspace allocated to Finance if the usage by HR exceeds some threshold. In one embodiment (decision step 210, NO branch), dynamic chargeback program 136 determines that the usage delta does not exceed a threshold; therefore, dynamic chargeback program 136 returns to step 204 to continue identifying people. For example, in the first month (as discussed above), the floorspace usage delta between Sales, Engineering, HR, and Finance does not exceed a threshold so the program on the company server continues to monitor the employees of the four organizations. In the embodiment (decision step 210, YES branch), dynamic chargeback program 136 determines that the usage delta does exceed a threshold; therefore, dynamic chargeback program 136 proceeds to step 212 to transmit a notification. For example, in the second month (as discussed above), the floorspace usage of Sales and Engineering (based on the total available floorspace) both exceed a plus/minus twenty percent delta (i.e., in the second month, Sales' usage of the floorspace was zero rather than one-fourth and Engineering's usage of the floorspace was fifty percent rather than twenty-five percent) so the program on the company server transmits a notification.

According to an embodiment, dynamic chargeback program 136 transmits a notification (step 212). In other words, responsive to determining that floorspace usage delta exceeds a threshold, dynamic chargeback program 136 transmits at least one notification to at least one affected organization. In an embodiment, dynamic chargeback program 136 uses any technology known in the art to transmit the at least one notification (e.g., e-mail, text message, voicemail, etc.). At a minimum, the notification will provide the name(s) of the organization, the current floorplan allocation, the real-time floorplan usage, the usage delta, the threshold, and the time period. According to an embodiment, dynamic chargeback program 136 transmits at least one notification over network 110 to the organization(s) whose floorspace usage exceeded the threshold. For example, the program on the company server transmits a first notification to the Sales organization informing the organization that their usage of their allocated floorspace over the last month was zero instead of the allocated twenty-five percent so the delta usage was minus one hundred percent and the threshold was minus ten percent. Therefore, their usage cost for the month would be decreasing from the normal usage cost. Continuing the example, the program on the company server transmits a second notification to the Engineering organization informing the organization that their usage of their allocated floorspace over the last month was one hundred percent and that their additional floorspace usage was an additional one hundred percent (as they utilized the entire floorspace allocated to Sales) resulting in a floorspace usage delta of one hundred percent against the threshold of ten percent. Therefore, their usage cost for the month would be increasing from the normal usage cost.

In an embodiment, dynamic chargeback program 136 calculates an adjusted chargeback (step 214). In other words, based on the actual floorspace usage and the associated usage delta, dynamic chargeback program 136 calculates adjusted chargebacks for the impacted organizations. According to an embodiment, dynamic chargeback program 136 determines whether the adjustment to the chargeback is an increase in cost associated with using more than the allocated floorspace or a decrease in cost associated with using less than the allocated floorspace. The chargeback adjustment is based on the determined usage delta that exceeds the threshold and is further based on the normal usage cost. In an embodiment, dynamic chargeback program 136 calculates an adjusted chargeback for each of the organizations whose usage delta exceeded a threshold. For example, the adjusted chargeback for the Sales organization, based on their usage delta of minus one hundred percent, is minus one hundred percent of their normal cost (i.e., Sales will not be charged for any floorspace usage for the past month as they did not utilize floorspace over the last month). However, the adjusted chargeback for Engineering is plus one hundred percent of their normal cost as they utilized not only the floorspace allocated to the organization but also the floorspace allocated to Sales.

According to an embodiment of the present invention, dynamic chargeback program 136 stores information (step 216). In other words, responsive to transmitting at least one notification, dynamic chargeback program 136 stores the transmitted information to a memory. In an embodiment, dynamic chargeback program 136 stores the information included in the notification and the data used to create the notification (i.e., the floorspace allocation information, the usage delta, etc.). According to an embodiment, dynamic chargeback program 136 stores information to memory 134 on server device 130. For example, the program on the company server stores the notifications to the Sales and the Engineering organizations as well as the data used to create the notifications to a database on the server.

In an embodiment, dynamic chargeback program 136 transmits a revised invoice (step 218). In other words, dynamic chargeback program 136 transmits a revised invoice to the impacted organizations based on the calculated adjusted chargebacks. According to an embodiment of the present invention, dynamic chargeback program 136 includes an updated cost to the organization in the revised invoice which is based on the calculated adjusted chargeback. The updated cost is based on the time period (e.g., a month, a quarter, a year, etc.) used in the determination of the whether a usage delta exceeded a threshold. The revised invoice is transmitted using any known technologies (e.g., e-mail, test message, voicemail, etc.). In an embodiment, dynamic chargeback program 136 transmits at least one revised invoice over network 110 to an organization that exceeded, by a threshold amount, their floorplan usage allocation. For example, the program on the company server transmits two revised invoices. The first revised invoice is transmitted to the Sales organization indicating that their floorspace cost for the past month is ‘$0’ as their delta usage was minus one hundred percent of their normal cost of ‘$2500’. The second revised invoice is transmitted to the Engineering organization indicating that their floorspace cost for the past month is ‘$5000’ as their delta usage was one hundred percent of their normal cost of ‘$2500’.

According to an embodiment, dynamic chargeback program 136 recommends a new allocation (step 220). In other words, based on the determined floorspace usage delta, dynamic chargeback program 136 recommends a new floorspace allocation. In an embodiment, the recommendation may be to monitor the usage for another time period to determine if the usage trend continues. In another embodiment, the recommendation may be to revise the floorspace allocations based on the usage identified over the past time period. The recommendation is made by transmitting the information to the appropriate organization(s) using any known technology (e.g., e-mail, text message, voicemail, etc.). According to an embodiment, dynamic chargeback program 136 recommends a new floorspace allocation; said recommendation is transmitted to the appropriate organizations over network 110. For example, the program on the company server recommends that the Sales organization should lose their floorspace allocation and further recommends that the Engineering organization should double their floorspace allocation.

In an embodiment, dynamic chargeback program 136 determines whether the new allocation is approved (decision step 222). In other words, responsive to recommending a new floorspace allocation, dynamic chargeback program 136 determines whether the recommended allocation is approved. According to an embodiment, the approval may be an indication from the impacted organization that the recommended allocation is acceptable. In one embodiment (decision step 222, NO branch), dynamic chargeback program 136 determines that the new allocation is not approved; therefore, dynamic chargeback program 136 returns to step 204 to continue identifying people. In the embodiment (decision step 222, YES branch), dynamic chargeback program 136 determines that the new allocation is approved; therefore, dynamic chargeback program 136 proceeds to step 224 to store the new allocation.

According to an embodiment of the present invention, dynamic chargeback program 136 stores a new allocation. In other words, responsive to determining that the new floorspace allocation is approved, dynamic chargeback program 136 stores the new floorspace allocation. In an embodiment, dynamic chargeback program 136 stores the new allocation to a memory. Upon storing the new allocation, dynamic chargeback program 136 may rename what was the “current floorspace allocation” as the “previous floorspace allocation” so that an accurate record is maintained over time of the floorspace allocation. According to an embodiment, dynamic chargeback program 136 stores the new and approved floorspace allocation to memory 134 on server device 130. For example, the program on the company server stores the information that Sales has no floorspace allocated to the organization and Engineering has an allocation of fifty percent of the floorspace allocated to the organization. HR and Finance each keep their previous twenty-five percent allocations.

The following paragraphs discuss briefly some other embodiments where dynamic chargeback program 136 may be beneficial in providing improvements to financial technologies.

In a first embodiment, dynamic chargeback program 136 can monitor trends rather than usage delta thresholds. For example, the trends can identify if an organization is paying for too much floorspace; i.e., if HR is allocated fifty percent of an area but only utilizes forty percent of the floorspace over a two week period, dynamic chargeback program 136 can recommend a reduction in the allocation allotted to HR. A user is able to customize set points used by dynamic chargeback program 136. For example, if an organization uses ‘X’ percent less than its allocated floorspace for ‘Y’ number of days, a ‘Z’ percent reduction of allocated space is recommended.

In a second embodiment, dynamic chargeback program 136 can help to prevent excessive charges for utilization of space not allocated to the organization. For example, assume that the normal cost of floorspace in a standard allocation is ‘$100’ per square foot. However, if a first organization utilizes space that is allocated to a second organization, that first organization is charged ‘$135’ per square foot. By using dynamic chargeback program 136, the first organization is able to determine that it needs additional allocated floorspace and once it is allocated, the first organization will realize cost savings.

In a third embodiment, dynamic chargeback program 136 can be used in a granular level; for example, identifying individual desk usage by person. This allows an organization to better utilize floorspace thus improving productivity and team morale. In an example, dynamic chargeback program 136 may identify that over a period of two months, desks ‘A’, ‘B’, and ‘C’ are unused even though they are assigned to three employees in Sales. Further, dynamic chargeback program 136 identifies that those three Sales employees have utilized desks ‘D’, ‘E’, and ‘F’ which are located much closer to the Marketing organization than desks ‘A’, ‘B’, and ‘C’. Thus, dynamic chargeback program 136 can identify a need for reorganization base on this real-time, actual usage of assets.

In a fourth embodiment, dynamic chargeback program 136 can help an organization meet budgetary constraints. For example, assume organization ‘T’ is allocated fifteen days usage of floorspace per month in an office building. If the employees of organization ‘T’ utilize the allocated floorspace, work from home, and also travel extensively, dynamic chargeback program 136 can identify when one or more employees have used their fifteen days of allocated floorspace and notify said employees of the need to work from home or travel for the balance of the month so that organization ‘T’ does not accrue charges for additional floorspace usage beyond the allocated fifteen days per month.

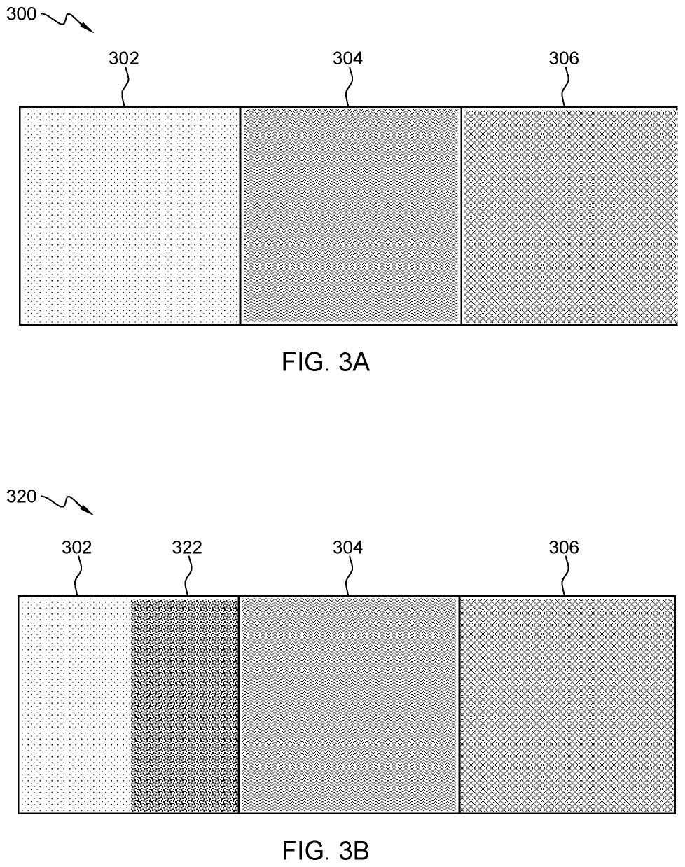

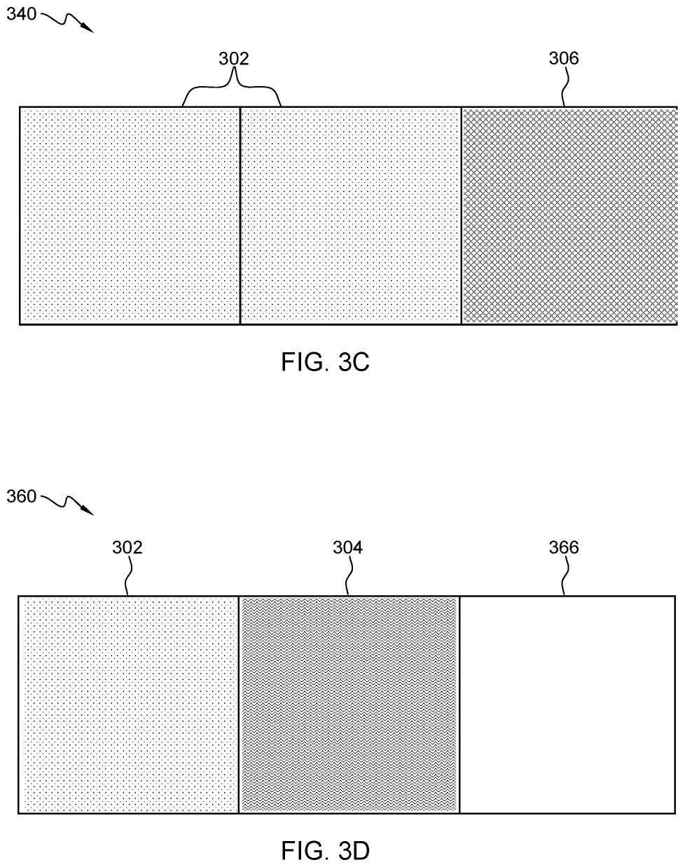

FIG. 3A depicts example 300 of floorspace allocated to three organizations, namely organization ‘A’ 302, organization ‘B’ 304, and organization ‘C’ 306. Each respective organization has a one-third allocation of the floorspace; accordingly, each organization pays one-third of the overall floorspace cost. For example, if the overall floorspace costs three thousand dollars per quarter, each organization is charged one thousand dollars per quarter.

FIG. 3B depicts example 320 showing the average floorspace usage for the second quarter of the year (i.e., the three months April, May, and June). Both organization ‘B’ 304 and organization ‘C’ 306 utilize their normally allocated floorspace of one-third. The respective chargebacks for each of organization ‘B’ 304 and organization ‘C’ 306 would not change. However, organization ‘A’ 302 is only utilizing half of its allocated space and organization ‘D’ 322 is using half of what was originally floorspace allocated to organization ‘A’ 302. Accordingly, the chargeback for organization ‘A’ would be half of its normal cost (i.e., five hundred dollars for the quarter) while the chargeback for organization ‘D’ 322 would be its normal cost (not depicted in example 320) plus an additional five hundred dollars for using half of the space allocated to organization ‘A’ 302.

FIG. 3C depicts example 340 showing the average floorspace usage for the third quarter of the year (i.e., the three months of July, August, and September). In this time period, organization ‘A’ 302 has doubled its normal floorspace allocation while organization ‘B’ 304 has no floorspace usage in the quarter. Organization ‘C’ 306 has its normal one-third usage. Therefore, the chargeback for organization ‘C’ 306 would not change (i.e., the chargeback is the normal one thousand dollars) while the chargeback for organization ‘A’ 302 would double to a total cost of two thousand dollars for the second quarter.

FIG. 3D depicts example 360 showing the average floorspace usage for the fourth quarter of the year (i.e., the three months of October, November, and December). In this time period, organization ‘A’ 302 and organization ‘B’ 304 both utilize their allocated one-third of the overall floorspace. However, organization ‘C’ 306 has not utilized their allocated floorspace this quarter as indicated by empty floorspace 366 (i.e., the floorspace is not utilized by any specific organization). Accordingly, the chargebacks for both of organization ‘A’ 302 and organization ‘B’ 304 remains the normal one thousand dollars. The chargeback for organization ‘C’ 306 is zero dollars since they did not utilize their allocated floorspace. The owner, or landlord, of empty floorspace 366 must cover the normal expense of one thousand dollars for the non-utilized floorspace.

FIG. 4 depicts computer system 400, which is an example of a system that includes dynamic chargeback program 136. Computer system 400 includes processors 401, cache 403, memory 402, persistent storage 405, communications unit 407, input/output (I/O) interface(s) 406 and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processors 401 by holding recently accessed data, and data near recently accessed data, from memory 402.

Program instructions and data used to practice embodiments of the present invention may be stored in persistent storage 405 and in memory 402 for execution by one or more of the respective processors 401 via cache 403. In an embodiment, persistent storage 405 includes a magnetic hard disk drive. Alternatively, or in addition to a magnetic hard disk drive, persistent storage 405 can include a solid-state hard drive, a semiconductor storage device, read-only memory (ROM), erasable programmable read-only memory (EPROM), flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data used to practice embodiments of the present invention may be downloaded to persistent storage 405 through communications unit 407.

I/O interface(s) 406 allows for input and output of data with other devices that may be connected to each computer system. For example, I/O interface 406 may provide a connection to external devices 408 such as a keyboard, keypad, a touch screen, and/or some other suitable input device. External devices 408 can also include portable computer readable storage media such as, for example, thumb drives, portable optical or magnetic disks, and memory cards. Software and data used to practice embodiments of the present invention can be stored on such portable computer readable storage media and can be loaded onto persistent storage 405 via I/O interface(s) 406. I/O interface(s) 406 also connect to display 409.

Display 409 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

1. A method, the method comprising:
determining, by one or more computer processors, an average usage of floorspace by one or more organizations utilizing the floorspace;
determining, by one or more computer processors, a machine learning model for associating individuals of the one or more organizations with usage of portions of the floorspace based, at least in part, on data recordings from plurality of information of things (IoT) sensors located throughout the floorspace;
responsive to determining that for at least one organization of the one or more organizations a usage delta between the average usage of floorspace and an allocated floorspace amount associated with the at least one organization exceeds a threshold based, at least in part, on the machine learning model, calculating, by one or more computer processors, an adjusted cost associated with the at least one organization;
receiving an input set indicative of quantity of time of floorspace that are allocated to individuals of a first organization from the one or more organizations utilizing the floorspace; and
identifying, by one or more computer processors, an individual associated with the first organization that has occupied floorspace allocated to the first organization for the quantity of time in the input set based, at least in part, on the machine learning model.

2. The method of claim 1, further comprising:
responsive to identifying the individual associated with the first organization that has occupied floorspace allocated to the first organization for the quantity of time in the input set, outputting a notification based, at least in part, on the identified individual.

3. The method of claim 1, wherein the step of determining, by one or more computer processors, an average usage of floorspace by one or more organizations utilizing the floorspace, comprises:
receiving, by one or more computer processors, input of a current floorspace allocation based on one or more organizations occupying the floorspace;
identifying, by one or more computer processors, one or more opted-in users utilizing the floorspace over a period of time;
determining, by one or more computer processors, an association between each identified user included in the one or more opted-in users and an organization of the one or more organizations; and
determining, by one or more computer processors, an average usage of floorspace of each organization in the one or more organizations over the period of time.

4. The method of claim 3, wherein the step of identifying, by one or more computer processors, one or more opted-in users utilizing the floorspace over a period of time, comprises:
receiving, by one or more computer processors, data from one or more Internet of things devices, wherein the one or more Internet of things devices are capable of identifying individual users included in the one or more opted-in users; and
identifying, by one or more computer processors, the one or more opted-in users utilizing the floorspace over the period of time based on the received data from the one or more Internet of things devices.

5. The method of claim 1, further comprising:
responsive to determining that for at least one organization of the one or more organization a usage delta between the average usage of floorspace and an allocated floorspace amount associated with the at least one organization exceeds a delta, transmitting, by one or more computer processors, a notification to the at least one organization;
calculating, by one or more computer processors, the adjusted cost associated with the at least one organization;
storing, by one or more computer processors, information associated with the calculated adjusted cost to a memory;
transmitting, by one or more computer processors, a revised invoice which includes an updated cost for the average usage of the floorspace by the at least one organization;
recommending, by one or more computer processors, a new floorspace allocation based on the usage delta between the average usage of floorspace and the allocated floorspace amount associated with the at least one organization; and
responsive to receiving an indication that the recommended new floorspace allocation is approved, storing by one or more computer processors, the new floorspace allocation to the memory.

6. The method of claim 4, wherein the one or more Internet of things devices include still cameras, video cameras, sensors that measure wireless fidelity signals, voice recognition devices, employee badge reader devices, and sensors that detect electromagnetic radiation from electronic devices.

7. The method of claim 1, wherein:
the adjusted cost is one of an increase in cost associated with using more than the allocated floorspace associated with the at least one organization and a decrease in cost associated with using less than the allocated floorspace associated with the at least one organization;
the adjusted cost is based on the determined usage delta that exceeds the threshold; and
the adjusted cost is further based on a normal cost of the allocated floorspace associated with the at least one organization.

8. A computer program product, the computer program product comprising:
one or more computer readable storage media; and
program instructions stored on the one or more computer readable storage media, the program instructions comprising:
program instructions to determine an average usage of floorspace by one or more organizations utilizing the floorspace;
program instructions to determine a machine learning model for associating individuals of the one or more organizations with usage of portions of the floorspace based, at least in part, on data recordings from plurality of information of things (IoT) sensors located throughout the floorspace;
responsive to determining that for at least one organization of the one or more organizations a usage delta between the average usage of floorspace and an allocated floorspace amount associated with the at least one organization exceeds a threshold based, at least in part, on the machine learning model, program instructions to calculate an adjusted cost associated with the at least one organization;
receiving an input set indicative of quantity of time of floorspace that are allocated to individuals of a first organization from the one or more organizations utilizing the floorspace; and
program instruction to identify an individual associated with the first organization that has occupied floorspace allocated to the first organization for the quantity of time in the input set based, at least in part, on the machine learning model.

9. The computer program product of claim 8, further comprising program instructions stored on the one or more computer readable storage media, to:
responsive to identifying the individual associated with the first organization that has occupied floorspace allocated to the first organization for the quantity of time in the input set, program instructions to output a notification based, at least in part, on the identified individual.

10. The computer program product of claim 8, wherein the program instructions to determine an average usage of floorspace by one or more organizations utilizing the floorspace, comprise:
program instructions to receive input of a current floorspace allocation based on one or more organizations occupying the floorspace;
program instructions to identify one or more opted-in users utilizing the floorspace over a period of time;
program instructions to determine an association between each identified user included in the one or more opted-in users and an organization of the one or more organizations; and
program instructions to determine an average usage of floorspace of each organization in the one or more organizations over the period of time.

11. The computer program product of claim 10, wherein the program instructions to identify one or more opted-in users utilizing the floorspace over a period of time, comprise:
program instructions to receive data from one or more Internet of things devices, wherein the one or more Internet of things devices are capable of identifying individual users included in the one or more opted-in users; and
program instructions to identify the one or more opted-in users utilizing the floorspace over the period of time based on the received data from the one or more Internet of things devices.

12. The computer program product of claim 8, further comprising program instructions stored on the one or more computer readable storage media, to:
responsive to determining that for at least one organization of the one or more organization a usage delta between the average usage of floorspace and an allocated floorspace amount associated with the at least one organization exceeds a delta, transmit a notification to the at least one organization;
calculate the adjusted cost associated with the at least one organization;
store information associated with the calculated adjusted cost to a memory;
transmit a revised invoice which includes an updated cost for the average usage of the floorspace by the at least one organization;
recommend a new floorspace allocation based on the usage delta between the average usage of floorspace and the allocated floorspace amount associated with the at least one organization; and
responsive to receiving an indication that the recommended new floorspace allocation is approved, store the new floorspace allocation to the memory.

13. The computer program product of claim 11, wherein the one or more Internet of things devices include still cameras, video cameras, sensors that measure wireless fidelity signals, voice recognition devices, employee badge reader devices, and sensors that detect electromagnetic radiation from electronic devices.

14. The computer program product of claim 8, wherein:
the adjusted cost is one of an increase in cost associated with using more than the allocated floorspace associated with the at least one organization and a decrease in cost associated with using less than the allocated floorspace associated with the at least one organization;
the adjusted cost is based on the determined usage delta that exceeds the threshold; and
the adjusted cost is further based on a normal cost of the allocated floorspace associated with the at least one organization.

15. A computer system, the computer system comprising:
one or more computer processors;
one or more computer readable storage media; and
program instructions stored on the one or more computer readable storage media for execution by at least one of the one or more computer processors, the program instructions comprising:
program instructions to determine an average usage of floorspace by one or more organizations utilizing the floorspace;
program instructions to determine a machine learning model for associating individuals of the one or more organizations with usage of portions of the floorspace based, at least in part, on data recordings from plurality of information of things (IoT) sensors located throughout the floorspace;
responsive to determining that for at least one organization of the one or more organizations a usage delta between the average usage of floorspace and an allocated floorspace amount associated with the at least one organization exceeds a threshold based, at least in part, on the machine learning model, program instructions to calculate an adjusted cost associated with the at least one organization;
receiving an input set indicative of quantity of time of floorspace that are allocated to individuals of a first organization from the one or more organizations utilizing the floorspace; and
program instructions to identify an individual associated with the first organization that has occupied floorspace allocated to the first organization for the quantity of time in the input set based, at least in part, on the machine learning model.

16. The computer system of claim 15, further comprising program instructions stored on the one or more computer readable storage media for execution by at least one of the one or more computer processors, to:
responsive to identifying the individual associated with the first organization that has occupied floorspace allocated to the first organization for the quantity of time in the input set, program instructions to output a notification based, at least in part, on the identified individual.

17. The computer system of claim 15, wherein the program instructions to determine an average usage of floorspace by one or more organizations utilizing the floorspace, comprise:
program instructions to receive input of a current floorspace allocation based on one or more organizations occupying the floorspace;
program instructions to identify one or more opted-in users utilizing the floorspace over a period of time;
program instructions to determine an association between each identified user included in the one or more opted-in users and an organization of the one or more organizations; and
program instructions to determine an average usage of floorspace of each organization in the one or more organizations over the period of time.

18. The computer system of claim 17, wherein the program instructions to identify one or more opted-in users utilizing the floorspace over a period of time, comprise:
program instructions to receive data from one or more Internet of things devices, wherein the one or more Internet of things devices are capable of identifying individual users included in the one or more opted-in users; and
program instructions to identify the one or more opted-in users utilizing the floorspace over the period of time based on the received data from the one or more Internet of things devices.

19. The computer system of claim 15, further comprising program instructions stored on the one or more computer readable storage media for execution by at least one of the one or more computer processors, to:
responsive to determining that for at least one organization of the one or more organization a usage delta between the average usage of floorspace and an allocated floorspace amount associated with the at least one organization exceeds a delta, transmit a notification to the at least one organization;
calculate the adjusted cost associated with the at least one organization;
store information associated with the calculated adjusted cost to a memory;
transmit a revised invoice which includes an updated cost for the average usage of the floorspace by the at least one organization;
recommend a new floorspace allocation based on the usage delta between the average usage of floorspace and the allocated floorspace amount associated with the at least one organization; and
responsive to receiving an indication that the recommended new floorspace allocation is approved, store the new floorspace allocation to the memory.

20. The computer system of claim 18, wherein the one or more Internet of things devices include still cameras, video cameras, sensors that measure wireless fidelity signals, voice recognition devices, employee badge reader devices, and sensors that detect electromagnetic radiation from electronic devices.
